(19) United States
(12) Patent Application Publication
(10) Pub. No.: US 2007/0067374 A1
(43) Pub. Date: Mar. 22, 2007

(54) Random Number Generating Circuit

(75) Inventors: Akira Iketani, Gunma-ken (JP); Shizuka Ishimura, Gunma-ken (JP); Kazumasa Chigira, Gunma-ken (JP)

Correspondence Address: FISH & RICHARDSON P.C., P.O. BOX 1022, MINNEAPOLIS, MN, 55440-1022, US

(73) Assignee: SANYO ELECTRIC CO., LTD, Osaka (JP)

(21) Appl. No.: 11/275,874

(22) Filed: Feb. 1, 2006

(30) Foreign Application Priority Data
Feb. 3, 2005 (JP) 2005-028113
Feb. 3, 2005 (JP) 2005-028114

(51) Int. Cl. G06F 7/58

(52) U.S. Cl. 708/250

(57) ABSTRACT

A random number generating circuit comprises a pseudo random number generating circuit that generates pseudo random numbers of an M-sequence; a physical random number generating circuit that generates physical random numbers; and a modulation circuit that modulates the physical random numbers generated by the physical random number generating circuit with the use of the pseudo random numbers generated by the pseudo random number generating circuit. The pseudo random number generating circuit can generate pseudo random numbers of a plurality of the M-sequences, and switches the M-sequences generated by the pseudo random number generating circuit based on the physical random numbers generated by the physical random number generating circuit.

### CROSS-REFERENCE TO RELATED APPLICATIONS

The present application claims priority from Japanese Patent Applications No. 2005-028113 and No. 2005-028114 both filed on Feb. 3, 2005 which are herein incorporated by reference.

### BACKGROUND OF THE INVENTION

1. Field of the Invention

The present invention relates to a random number generating circuit generating random numbers used for data encryption, etc.

2. Description of the Related Art

Recently, in various information processing systems, data are encrypted. In the encryption, random numbers are often used for improving security. Such random numbers include, for example, pseudo random numbers such as an M-sequence (Maximum Length Code) that can be generated with the use of a linear feedback shift register. As random numbers other than pseudo random numbers such as the M-sequence, physical random numbers are known which use natural phenomena such as a nuclear decay phenomenon occurring in random order or electrical noises, and the physical random numbers can be used for encryption (e.g., Japanese Patent Application Laid-Open Publication No. 2000-66592). By combining the pseudo random numbers such as the M-sequence generated by the linear feedback shift register and the physical random numbers, a level of prediction difficulty can be increased in random numbers (e.g., Japanese Patent Application Laid-Open Publication No. 2004-157168).

However, since pseudo random numbers such as the M-sequence are generated from a certain arithmetic process or a combination of functions, when the same initial conditions are provided, identical values are generated and thus the random numbers can be predicted. Therefore, if pseudo random numbers such as the M-sequence are used for encryption, it cannot be said that the security is adequate.

If transistor noises are used to generate physical random numbers “0” and “1”, since a probability of “0” to occur is generally in the range of 45 to 55% and a great difference exists between frequencies of “0” and “1” to occur, the transistor noises cannot be used to generate random numbers. Since the physical random numbers are generally weak signals, when used for encryption, the physical random numbers are often amplified with the use of an amplifier to a level for use in encryption. Such physical random numbers amplified by an amplifier may be affected by an electric field or a magnetic field. Therefore, with the changes in an electric field or a magnetic field by external influences, there were possibilities for the random numbers to be manipulated and thus lower the level of security.

In a random number generating apparatus disclosed in Japanese Patent Application Laid-Open Publication No. 2004-157168, tap positions in the generation of the M-sequence is defined in advance and a circuit is configured for performing exclusive OR of a bit corresponding to the tap positions of a linear feedback shift register. Therefore, after configuring the random number generating apparatus, the tap positions thereof cannot be changed and thus it cannot be said that the security is adequate.

### SUMMARY OF THE INVENTION

The present invention was conceived in consideration of the above problems, and it is therefore an object of the present invention to provide a random number generating circuit capable of generating random numbers that are secure as well as difficult to predict.

According to the present invention in order to achieve the above and other objects, one aspect of the present invention is a random number generating circuit which comprises a pseudo random number generating circuit that generates pseudo random numbers of a pseudo random number sequence; a physical random number generating circuit that generates physical random numbers; and a modulation circuit that changes the physical random numbers generated by the physical random number generating circuit depending on the pseudo random numbers generated by the pseudo random number generating circuit and outputs the changed physical random numbers.

Another aspect of the present invention is a random number generating circuit which comprises a pseudo random number generating circuit that generates pseudo random numbers of a plurality of pseudo random number sequences; and a physical random number generating circuit that generates physical random numbers, wherein the pseudo random number generating circuit switches the pseudo random number sequences generated by the pseudo random number generating circuit based on the physical random numbers generated by the physical random number generating circuit.

Yet another aspect of the present invention is a random number generating circuit which comprises a linear feedback shift register that generates pseudo random numbers of a pseudo random number sequence; a register that stores tap positions of the pseudo random number sequence; and a feedback signal generating circuit that generates a feedback signal to the linear feedback shift register based on data stored in the linear feedback shift register and the tap positions stored in the register.

Further aspect of the present invention is a random number generating circuit which comprises a linear feedback shift register that generates pseudo random numbers of a pseudo random number sequence; a plurality of registers that stores respective tap positions of a plurality of the pseudo random number sequences; a selection circuit that receives a selection signal indicating which pseudo random number sequence is to be used among the plurality of the pseudo random number sequences, and selects any one of the registers based on the selection signal; and a feedback signal generating circuit that generates a feedback signal to the linear feedback shift register based on data stored in the linear feedback shift register and the tap positions stored in the register selected by the selection circuit.

According to the present invention, random numbers that are secure as well as difficult to predict can be generated.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a diagram showing an overall configuration of a keyless entry system for locking/unlocking a lock of a vehicle, which is an implementation using a random number generating circuit according to the present invention;

FIG. 2 is a diagram showing a configuration of a data processing circuit;

FIG. 3 is a flowchart showing a communication procedure between a child device and a parent device of the keyless entry system;

FIG. 4 is a diagram showing a configuration of a random number generating circuit;

FIG. 5 is a diagram showing a configuration of a physical random number generating circuit;

FIG. 6 is a timing chart of the random number generating circuit; and

FIG. 7 is a diagram showing probabilities of physical random numbers and pseudo random numbers to occur.

### DETAILED DESCRIPTION OF THE INVENTION

==Overall Configuration==

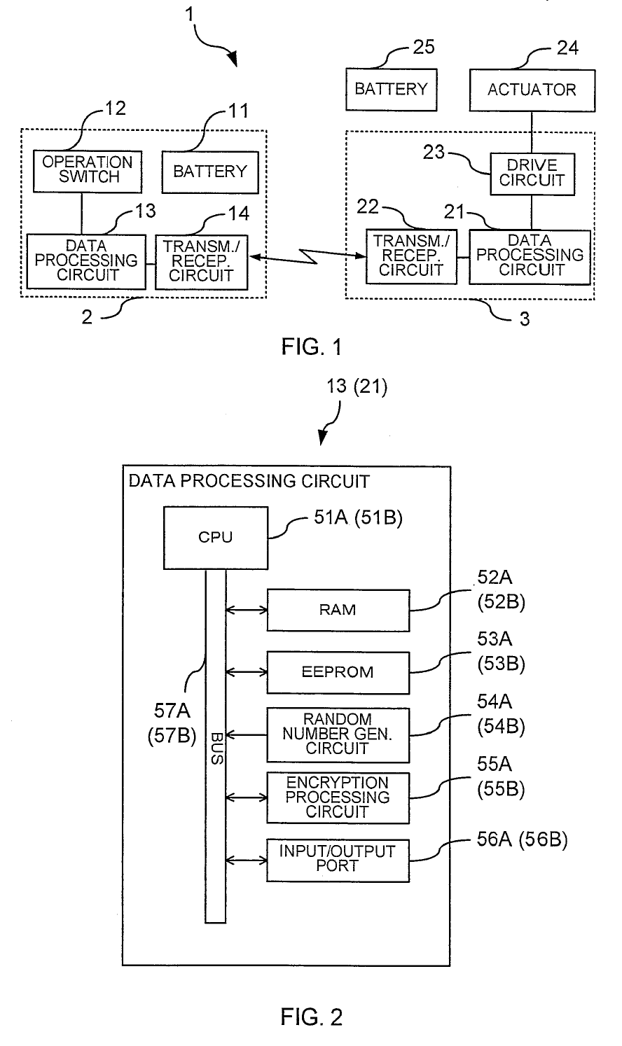

FIG. 1 is a diagram showing an overall configuration of a keyless entry system 1 for locking/unlocking a lock of a vehicle, which is an implementation using a random number generating circuit according to the present invention. The keyless entry system 1 includes a portable child device 2 and a parent device 3 mounted on the vehicle, etc. The child device 2 is installed in a handle portion, etc. of a key to be inserted into a key hole of a door lock or a steering lock of the vehicle, for example. The parent device 3 is installed in the vehicle.

The child device 2 is provided with a battery 11, an operation switch 12, a data processing circuit 13, and a transmission/reception circuit 14. The battery 11 is for the purpose of supplying electric power necessary for operating each unit of the child device 2. The operation switch 12 is a switch for accepting a locking/unlocking instruction from a user. The data processing circuit 13 performs such as generation of authentication data necessary for locking/unlocking. The transmission/reception circuit 14 is a circuit that converts digital data output from the data processing circuit 13 to analog data, which are amplified and sent as electromagnetic waves. The transmission/reception circuit 14 can also receive electromagnetic waves sent from the parent device 3 and convert them to digital data, which are input to the data processing circuit 13. As the electromagnetic waves, radio waves or infrared rays are used.

The parent device 3 is provided with a data processing circuit 21, a transmission/reception circuit 22, and a drive circuit 23. The data processing circuit 21 performs authentication processing, etc. based on the authentication data received from the child device 2. The transmission/reception circuit 22 is a circuit that receives electromagnetic waves output from the child device 2 and converts them to digital data, which are input to the data processing circuit 21. The transmission/reception circuit 22 can also convert digital data output from the data processing circuit 21 to analog data, which are amplified and sent as electromagnetic waves. The drive circuit 23 is a circuit that transmits a drive signal to an actuator 24 actuating a lock mechanism for locking/unlocking the lock of the vehicle. Each unit 21 to 23 of the parent device 3 is supplied with electric power from a battery 25 of the vehicle.

==Configuration of Data Processing Circuit==

FIG. 2 is a diagram showing a configuration of the data processing circuit 13. The data processing circuit 13 is provided with a CPU 51A, a RAM (Random Access Memory) 52A, an EEPROM (Electrically Erasable Programmable Read-Only Memory) 53A, a random number generating circuit 54A, an encryption processing circuit 55A, and an input/output port 56A. The units 51A to 56A are connected by a bus 57A in a manner enabling communication with each other.

The CPU 51A controls the data processing circuit 13 as a whole. The RAM 52A stores working data, etc. used by the CPU 51A. The EEPROM 53A is a rewritable nonvolatile memory and stores programs and archive data, etc. The random number generating circuit 54A is a circuit that generates random numbers used in the encryption process. The encryption processing circuit 55A is a circuit performing processing such as permutation or substitution in a common key block encryption system. The input/output port 56A is an interface transmitting/receiving data to/from the operation switch 12, the transmission/reception circuit 14, etc. located on the outside of the data processing circuit 13.

In the present implementation, the DES (Data Encryption Standard) is used as a common key block encryption system. In such a data processing circuit 13, DES encryption or decryption process is performed by executing a program or by controlling the encryption processing circuit 55A, etc. The data processing circuit 21 has the same configuration and is provided with a CPU 51B, a RAM 52B, an EEPROM 53B, a random number generating circuit 54B, an encryption processing circuit 55B, an input/output port 56B, and a bus 57B that connects units 51B to 56B in a manner enabling communication with each other.

==Communication Procedure==

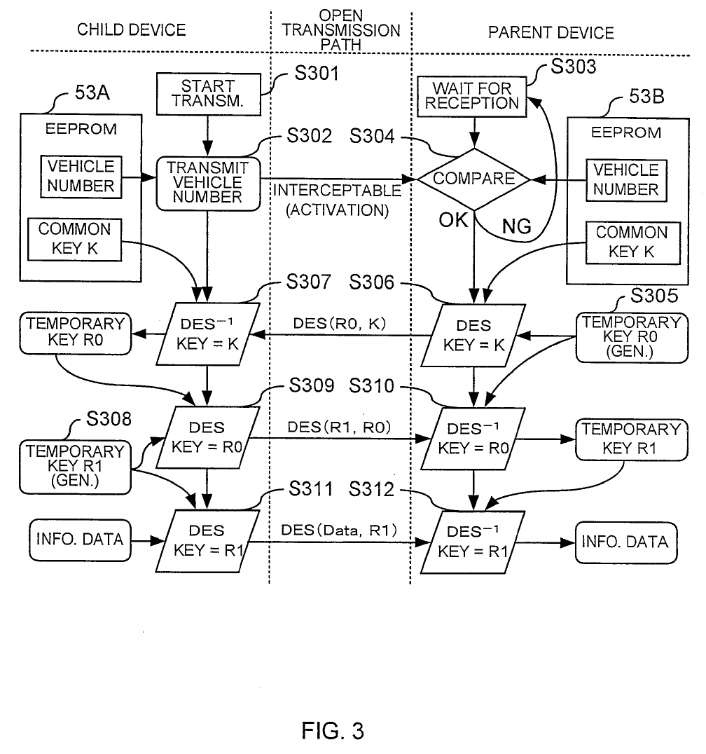

FIG. 3 is a flowchart showing a communication procedure between the child device 2 and the parent device 3 of the keyless entry system 1. Transmission process is activated, for example, by operating the operation switch 12 of the child device 2 (S301). The data processing circuit 13 of the child device 2 transmits a vehicle number (vehicle identification number) stored in the EEPROM 53A to the parent device 3 (S302). The data processing circuit 21 of the parent device 3 waits for the vehicle number to be transmitted from the child device 2 (S303) and when the parent device 3 receives the vehicle number transmitted from the child device 2, compares the vehicle number with a vehicle number stored in the EEPROM 53B (S304).

If the vehicle numbers are not identical (S304: NG), the data processing circuit 21 of the parent device 3 determines that a vehicle number of a different vehicle was transmitted and returns to the reception waiting state (S303). If the vehicle numbers are identical (S304: OK), the data processing circuit 21 uses the random number generating circuit 54B to generate a temporary key R0, which is a 64-bit random number (S305). The data processing circuit 21 uses a common key K stored in the EEPROM 53B to encrypt this temporary key R0 with the DES and transmits the encrypted temporary key R0 to the child device 2 (S306).

When receiving the encrypted temporary key R0 transmitted from the parent device 3, the data processing circuit 13 of the child device 2 uses a common key K stored in the EEPROM 53A to decrypt the temporary key R0 (S307). The data processing circuit 13 uses the random number generating circuit 54A to generate a temporary key R1, which is a 64-bit random number (S308). The data processing circuit 13 uses the temporary key R0 received from the parent device 3 to encrypt this temporary key R1 with the DES and transmits the encrypted temporary key R1 to the parent device 3 (S309). When receiving the encrypted temporary key R1 transmitted from the child device 2, the data processing circuit 21 of the parent device 3 uses the temporary key R0 to decrypt the encrypted temporary key R1 (S310).

The data processing circuit 13 of the child device 2 then uses the temporary key R1 to encrypt information data such as a locking/unlocking instruction with the DES and transmits the encrypted information data to the parent device 3 (S311). When receiving the encrypted information data transmitted from the child device 2, the data processing circuit 21 of the parent device 3 uses the temporary key R1 to decrypt the encrypted information data (S312). Based on the decrypted information data, the data processing circuit 21 transmits a locking/unlocking instruction signal to the actuator 24 via the drive circuit 23, for example.

In this way, in the keyless entry system 1, the child device 2 and the parent device 3 use the random number generating circuits 54A, 54B to generate the temporary keys and repeat the DES encryption and decryption processes to increase security strength.

==Configuration of Random Number Generating Circuit==

In the present implementation, the random number generating circuits 54A, 54B are used in the random number generating process in the encryption and decryption process described in FIG. 3. Since the random number generating circuit 54A and the random number generating circuit 54B have the same configuration, the random number generating circuit 54A will hereinafter be described.

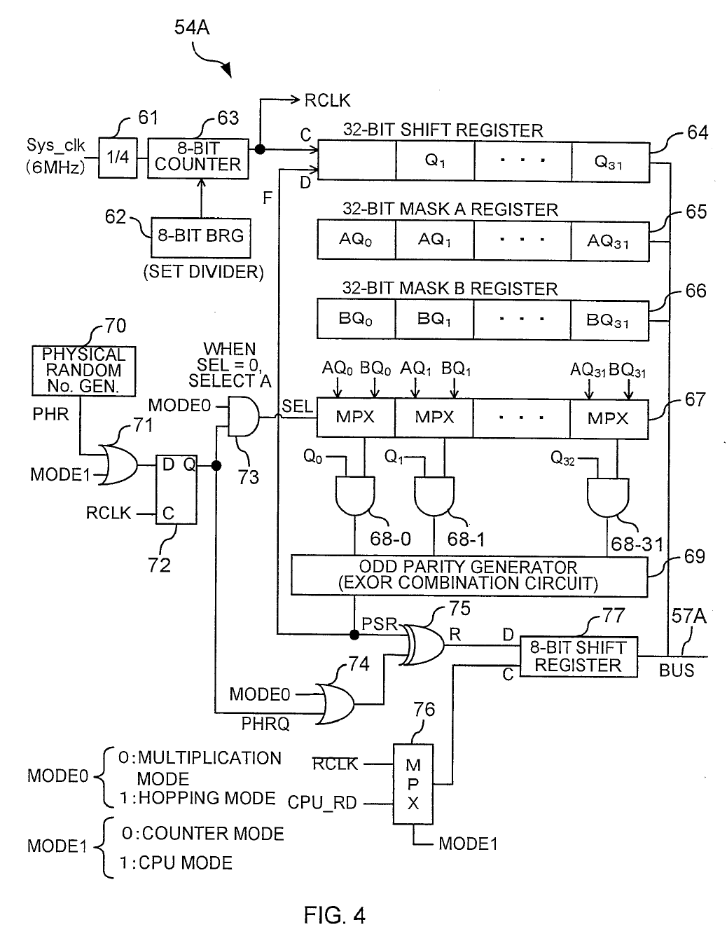

FIG. 4 is a diagram showing a configuration of the random number generating circuit 54A. The random number generating circuit 54A is provided with a divider circuit 61, a baud rate generator 62, a counter 63, a shift register 64, a mask A register 65, a mask B register 66, a multiplexer 67, an AND circuit 68, an odd parity generator 69, a physical random number generating circuit 70, an OR circuit 71, a D-type flip-flop (hereinafter, “D-FF”) 72, an AND circuit 73, an OR circuit 74, an EXOR circuit 75, a multiplexer 76, and a shift register 77. The shift register 64, the mask A register 65, the mask B register 66 and the shift register 77 are connected to the bus 57A.

The divider circuit 61 is a circuit for dividing, for example, a 6-MHz system clock (Sys_clk) in the data processing circuit 13 into four parts. The baud rate generator 62 is a circuit that can set a divide value to an 8-bit register, for example. The counter 63 counts the clock output from the divider circuit 61 based on the divide value set to the baud rate generator 62 to output the operation clock (RCLK) of the random number generating circuit 54A.

The shift register 64 is, for example, a 32-bit (Q₀ to Q₃₁) linear feedback shift register; the operation clock (RCLK) is input to a clock input (C); and a feedback signal (F) is input to a data input terminal (D) at a first bit (Q₀). An initial value of the shift register 64 is set by the CPU 51A through the bus 57A.

The mask A register 65 is, for example, a 32-bit (AQ₀ to AQ₃₁) register and stores tap positions when an M-sequence pseudo random number is generated by the shift register 64. For example, if a 4-bit M-sequence is generated with the use of the shift register 64, a feedback signal (F) can be obtained from the following equation (1) based on a primitive polynomial X⁴+X +1, for example.
F=Q₂⊕Q₃ (1)

In this case, the tap positions are a third bit and a fourth bit; for example, “1” is set to a third bit (AQ₂) and a fourth bit (AQ₃) of the mask A register 65; and for example, “0” is set to other bits of the mask A register 65.

Similarly, the mask B register 66 is, for example, a 32-bit (BQ₀ to BQ₃₁) register and stores tap positions different from the mask A register 65. For example, if a 4-bit M-sequence different from that of the above description is generated with the use of the shift register 64, the feedback signal (F) can be obtained from the following equation (2) based on a primitive polynomial X⁴+X³+1, for example.
F=Q₀⊕Q₃ (2)

In this case, the tap positions are a first bit and a fourth bit; for example, “1” is set to a first bit (BQ₀) and a fourth bit (BQ₃) of the mask B register 66; and for example, “0” is set to other bits of the mask B register 66. The values of the mask A register 65 and the mask B register 66 are set by the CPU 51A through the bus 57A.

Values (AQ₀ to AQ₃₁) of the mask A register 65 and values (BQ₀ to BQ₃₁) of the mask B register 66 are input to the multiplexer 67, which outputs an A part (AQ₀ to AQ₃₁) if a selection signal (SEL) is “0”, for example, outputs a B part (BQ₀ to BQ₃₁) if a selection signal (SEL) is “1”, for example.

The AND circuit 68 (68-0 to 68-31) is a circuit that performs a logical OR for each bit between values (Q₀ to Q₃₁) of the shift register 64 and the values (AQ₀ to AQ₃₁) of the mask A register 65 or the values (BQ₀ to BQ₃₁) of the mask B register 66 output from the multiplexer 67. Therefore, among the values (Q₀ to Q₃₁) of the shift register 64, the AND circuit 68 outputs a value stored in a bit for a bit corresponding to the tap position and outputs “0” for the other bits.

The odd parity generator 69 is a circuit performing exclusive-OR of the values output from the AND circuit 68. If the values (AQ₀ to AQ₃₁) of the mask A register 65 are output from the multiplexer 67, as shown in the following equation (3), a value output from the odd parity generator 69 becomes the feedback signal (F) to the shift register 64 in the case of generating the M-sequence based on the tap positions set to the mask A register 65.
F=Q₀·AQ₀⊕Q₁·AQ₁⊕ . . . ⊕Q₃₁·AQ₃₁ (3)

Similarly, if the values (BQ₀ to BQ₃₁) of the mask B register 66 are output from the multiplexer 6 7, as shown in the following equation (4), a value output from the odd parity generator 69 becomes the feedback signal (F) to the shift register 64 in the case of generating the M-sequence based on the tap positions set to the mask B register 66.
F=Q₀·BQ₀⊕Q₁·BQ₁⊕ . . . ⊕Q₃₁·BQ₃₁ (4)

In the present implementation, the feedback signals (F) output from the odd parity generator 69 are used as the M-sequence pseudo random numbers (PSR).

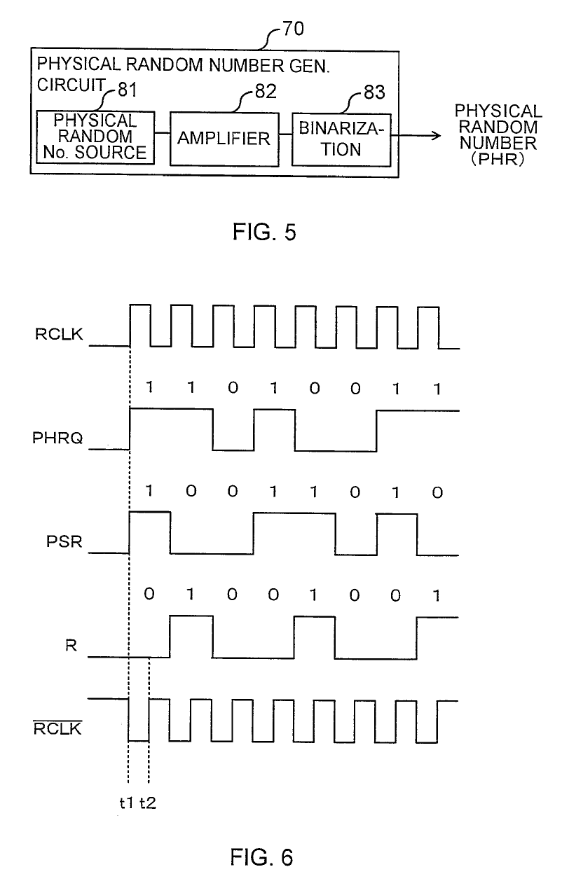

The physical random number generating circuit 70 is a circuit generating physical random numbers (PHR). FIG. 5 shows a configuration of the physical random number generating circuit 70. The physical random number generating circuit 70 is provided with a physical random number source 81, an amplifier circuit 82, and a binarization circuit 83. The physical random number source 81 may generate signals varying randomly based on a natural phenomenon and may include, for example, a semiconductor device generating noise signals generated in a current path including junctions as disclosed in Japanese Patent Application Laid-Open Publication No. 2000-66592. The physical random number source 81 is not limited to this and a source utilizing decay of radioactive material, etc. can also be used as the physical random number source 81.

The signal generated from the physical random number source 81 is amplified by the amplification circuit 82 and binarized by the binarization circuit 83. The binarization circuit 83 compares an amplitude of the amplified signal output from the amplifier circuit with a predetermined threshold value and outputs as the physical random number (PHR), for example, “1” if the amplitude of the amplified signal is higher than the predetermined threshold value or “0” if the amplitude is lower. The level of the threshold value in the binarization circuit 83 is set such that probabilities of “1” and “0” to occur are approximately 45 to 55%.

The OR circuit 71 is a circuit performing a logical OR of the physical random numbers (PHR) output from the physical random number generating circuit 70 and a selection signal (MODEL) indicating whether or not the physical random number is to be used in the random number generating circuit 54A. In the present implementation, a counter mode means that the selection signal (MODEL) is “0” and a CPU mode means that the selection signal (MODEL) is “1”. In the case of the counter mode, the signal output from the OR circuit 71 is the physical random number (PHR) output from the physical random number generating circuit 70 and the physical random number (PHR) is used in other circuits. On the other hand, in the case of the CPU mode, since the signal output from the OR circuit 71 is always “1”, the physical random number (PHR) is not used in other circuits.

The signal output from the OR circuit 71 is input to a data input terminal (D) of the D-FF 72. In the case of the counter mode, the physical random numbers (PHR) are input to the data input terminal (D) of the D-FF 72. The operation clock (RCLK) is input to the clock input terminal (c) of the D-FF 72. The physical random numbers (PHR) input to the data input terminal (D) of the D-FF 72 are output from a data output terminal (Q) as physical random numbers (PHRQ) at the time of the rising of the operation clock (RCLK).

The AND circuit 73 is a circuit that performs a logical AND of the physical random number (PHRQ) output from the D-FF 72 and a selection signal (MODE 0) selecting an operation mode in the random number generating circuit 54A to output a selection signal (SEL) to the multiplexer 67. In the present implementation, a multiplication mode means that the selection signal (MODE 0) is “0” and a hopping mode means that the selection signal (MODE 0) is “1”. The multiplication mode is a mode for changing the physical random numbers depending on the M-sequence pseudo random numbers for output and the hopping mode is a mode for switching the M-sequence based on the physical random numbers for output.

In the case of the multiplication mode, the selection signal (SEL) output from the AND circuit 73 is always “0”. Therefore, in the case of the multiplication mode, the multiplexer 67 outputs the values (AQ₀ to AQ₃₁) of the mask A register 65. In the case of the hopping mode, the selection signal (SEL) output from the AND circuit 73 is the physical random number (PHRQ) output from the D-FF 72. Therefore, in the hopping mode, the multiplexer 67 outputs the values (AQ₀ to AQ₃₁) of the mask A register 65 or the values (BQ₀ to BQ₃₁) of the mask B register 66 depending on the physical random numbers (PHRQ).

The OR circuit 74 is a circuit that performs a logical OR of the physical random number (PHRQ) and the selection signal (MODE0) of the operation mode. In the multiplication mode, the signal output from the OR circuit 74 is the physical random number (PHRQ) and, in the hopping mode, the signal is always “1” regardless of the physical random number (PHRQ).

The EXOR circuit 75 is a circuit that performs exclusive OR of the pseudo random numbers (PSR) output from the odd parity generator 69 and the signal output from the OR circuit 74 to output random numbers (R).

A clock (/RCLK) that is the inverse of the operation clock (RCLK), and a read signal (CPU_RD) from the CPU 51A are input to the multiplexer 76. The multiplexer 76 outputs the clock (/RCLK) in the case the selection signal (MODE1) is the counter mode and outputs the read signal (CPU_RD) in the case the selection signal (MODE1) is the CPU mode.

The shift register 77 is, for example, an 8-bit linear shift register; the random numbers (R) output from the EXOR circuit 75 are input to the data input terminal (D); and the clock signal (/RCLK) or the read signal (CPU_RD) output from the multiplexer 76 is input to the clock input terminal (C).

In the present implementation, the pseudo random number generating circuit of the present invention is constituted by the shift register 64, the mask A register 65, the mask B register 66, the multiplexer 67, the AND circuit 68 and the odd parity generator 69, and the modulation circuit is constituted by the EXOR circuit 75. In the present implementation, the selection circuit of the present invention is constituted by the multiplexer 67 and the feedback signal generating circuit of the present invention is constituted by the AND circuit 68 and the odd parity generator 69.

==Description of Operation of Random Number Generating Circuit==

An operation of the random number generating circuit 54A will be described.

(1) Multiplication Mode

Description will be made on the case where an operation mode of the counter mode is the multiplication mode. In the case of the multiplication mode, the selection signal (SEL) output from the AND circuit 73 is always “0” and the values (AQ₀ to AQ₃₁) of the mask A register 65 are output from the multiplexer 67. The results of the logical AND of the values (Q₀ to Q₃₁) of the shift register 64 and the values (AQ₀ to AQ₃₁) of the mask A register 65 are output from the AND circuit 68, and the feedback signal (F) to the shift register 64 is generated by the odd parity generator 69 performing exclusive OR thereof. The signal output from the odd parity generator 69 is input to the EXOR circuit 75 as the pseudo random number (PSR). This pseudo random number (PSR) is the M-sequence pseudo random number corresponding to the tap position set to the mask A register 65.

The EXOR circuit 75 performs exclusive OR of the pseudo random number (PSR) and the physical random number (PHRQ) output from the OR circuit 74, and outputs the random number (R) to the shift register 77. The clock (/RCLK) is input to the clock input terminal (C) of the shift register 77 through the multiplexer 76.

FIG. 6 is a timing chart showing an output timing of each signal. As shown in the figure, at the time of the rising of the operation clock (RCLK) (e.g., time t1), the physical random number (PHRQ) and the pseudo random number (PSR) are generated, and furthermore the random number (R) which is the exclusive OR thereof is generated. At the time of falling of the operation clock (RCLK), i.e., at the time of the rising of the clock (/RCLK) (e.g., time t2), the random number (R) is set to the shift register 77.

When the shift register 77 stores eight bits of the random numbers (R) output from the EXOR circuit 75, transmits an interrupt signal to the CPU 51A. When the CPU 5 A receives the interrupt signal, reads out the 8-bit random numbers (R) from the shift register 77.

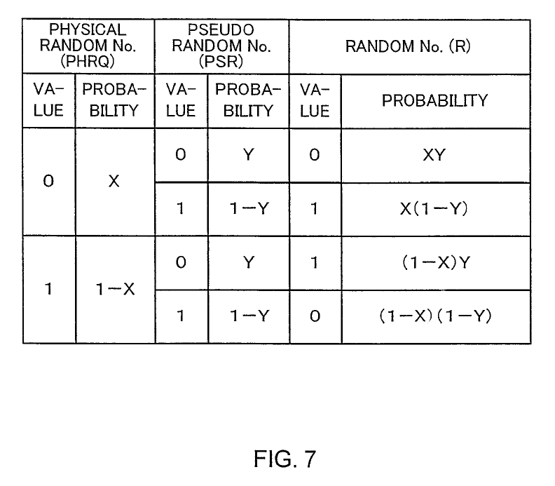

FIG. 7 is a table showing combinations of the physical random number (PHRQ) and the pseudo random number (PSR) input to the EXOR circuit 75 and the probabilities of occurrences thereof. Assuming that a probability of the physical random number (PHRQ) being “0” is X (0≦X≦1) and that a probability of the pseudo random number (PSR) being “0” is Y (0≦Y≦1), XY is a probability that both the physical random number (PHRQ) and the pseudo random number (PSR) are “0”, and X(1−Y) is a probability that the physical random number (PHRQ) is “0” and the pseudo random number (PSR) is “1”. (1−X)Y is a probability that the physical random number (PHRQ) is “1” and the pseudo random number (PSR) is “0”, and (1−X) (1−Y) is a probability that both the physical random number (PHRQ) and the pseudo random number (PSR) are “1”.

Therefore, a probability P₀ of the random number (R) being “0” and a probability P₁ of the random number (R) being “1” can be obtained from equations (5), (6).
P₀═XY+(1−X)(1−Y) (5)
P₁═X(1−Y)+(1−X)Y (6)

For example, assuming that the pseudo random numbers (PSR) are 16-bit M-sequences, in the pseudo random numbers (PSR), “0” is generated 32767 times and “1” is generated 32768 times, resulting in Y≈0.4999 (49.99%). Assuming that a probability X of “0” to occur in the physical random number (PHRQ) is, for example, 0.45 (45%), P₀ and P₁ are P₀≈0.50001 (50.001%) and P₁≈0.49999 (49.999%) from equations (5) and (6), respectively. For example, assuming that the probability X of “0” to occur in the physical random number (PHRQ) is, for example, 0.55 (55%), P₀ and P₁ are P₀≈0.49999 (49.999%) and P₁≈0.50001 (50.001%), respectively. Therefore, a probability of “0” to occur in the random numbers (R) is ranged from about 49.999 to 50.001%, and thus can be used as the random numbers.

(2) Hopping Mode

Description will be made on the case where an operation mode of the counter mode is the hopping mode. In the case of the hopping mode, the selection signal (SEL) output from the AND circuit 73 is the physical random number (PHRQ) output from the D-FF 72. Therefore, the multiplexer 67 outputs the values (AQ₀ to AQ₃₁) of the mask A register 65 if the physical random number (PHRQ) is “0” and outputs the values (BQ₀ to BQ₃,) of the mask B register 66 if the physical random number (PHRQ) is “1”.

If the physical random number (PHRQ) is “0”, the logical AND results of the values (Q₀ to Q₃₁) of the shift register 64 and the values (AQ₀ to AQ₃₁) of the mask A register 65 are output from the AND circuit 68, and the feedback signal (F) to the shift register 64 is generated by the odd parity generator 69 performing exclusive OR thereof. The signal output from the odd parity generator 69 is input to the EXOR circuit 75 as the pseudo random number (PSR).

If the physical random number (PHRQ) is “1”, the results of the logical AND of the values (Q₀ to Q₃₁) of the shift register 64 and the values (BQ₀ to BQ₃₁) of the mask B register 66 are output from the AND circuit 68, and the feedback signal (F) to the shift register 64 is generated by the odd parity generator 69 performing exclusive OR thereof. The signal output from the odd parity generator 69 is input to the EXOR circuit 75 as the pseudo random number (PSR).

Therefore, the pseudo random number (PSR) is the M-sequence pseudo random number corresponding to the tap positions set to the mask A register 65 if the physical random number (PHRQ) is “0” and is the M-sequence pseudo random number corresponding to the tap positions set to the mask B register 66 if the physical random number (PHRQ) is “1”.

In the case of the hopping mode, since the output from the OR circuit 74 is always “1”, the random number (R) output from the EXOR circuit 75 is the pseudo random number (PSR) inverted. The random number (R) is input to the data input terminal (D) of the shift register 77 and the clock (/RCLK) is input to the clock input terminal (C) through the multiplexer 76. As is the case with the multiplication mode, the random number (R) is set to the shift register 77 at the time of the rising of the clock (/RCLK). When the shift register 77 stores eight bits of the random numbers (R) output from the EXOR circuit 75, transmits an interrupt signal to the CPU 51A. The CPU 51A receives the interrupt signal and reads the 8-bit random numbers (R) from the shift register 77.

(3) CPU Mode

Description will be made of the operation of the CPU mode. In the case of the CPU mode, the signal (PHRQ) output from the D-FF 72 is always “1”. Therefore, the selection signal (SEL) output from the AND circuit 73 is “0” in the case of the multiplication mode and is “1” in the case of the hopping mode. Therefore, the multiplexer 67 outputs the values (AQ₀ to AQ₃₁) of the mask A register 65 in the case of the multiplication mode and outputs the values (BQ₀ to BQ₃₁) of the mask B register 66 in the case of the hopping mode.

The results of the logical AND of the values (Q₀ to Q₃₁) of the shift register 64 and the values (AQ₀ to AQ₃₁) of the mask A register 65 or the values (BQ₀ to BQ₃₁) of the mask B register 66 are output from the AND circuit 68, and the feedback signal (F) to the shift register 64 is generated by the odd parity generator 69 performing exclusive OR thereof. The signal output from the odd parity generator 69 is input to the EXOR circuit 75 as the pseudo random number (PSR). This pseudo random number (PSR) is the M-sequence pseudo random number corresponding to the tap positions set to the mask A register 65 or the mask B register 66.

In the case of the CPU mode, since the output of the OR circuit 74 is always “1”, the random number (R) output from the EXOR circuit 75 is the pseudo random number (PSR) inversed. The random number (R) is input to the data input terminal (D) of the shift register 77 and the read signal (CPU_RD) from the CPU 51A is input to the clock input terminal (C) through the multiplexer 76. In the shift register 77, the random number (R) is set every time the read signal (CPU_RD) is input. When the shift register 77 stores eight bits of the random numbers (R) output from the EXOR circuit 75, transmits an interrupt signal to the CPU 51A. When the CPU 51A receives the interrupt signal, reads out the 8-bit random numbers (R) from the shift register 77.

Description has been made on the keyless entry system 1 to which the random number generating circuits 54A, 54B are applied, being an implementation of the present invention. The M-sequence pseudo random numbers are random numbers where, the number of times zero is generated is only one less than one is generated, thus one and zero appear approximately the same number of times Therefore, in the case of the multiplication mode, by changing the physical random numbers depending on the M-sequence pseudo random numbers for output, i.e., by modulating the physical random numbers with the use of the M-sequence pseudo random numbers, the frequencies of one and zero outputs to occur are made equivalent to the M-sequence pseudo random numbers and the performance of the random numbers can be satisfied. Since the random numbers to be output are generated by modulating the physical random numbers with the M-sequence pseudo random numbers, differs from mere M-sequence pseudo random numbers and it is difficult to predict the output pattern thereof. Since the output random numbers are not the physical random numbers directly output, even if the physical random numbers are manipulated by external influences, security can be prevented from deteriorating as compared to the case of using only the physical random numbers, because the random numbers to be output are modulated by the M-sequence pseudo random numbers.

As described above, the physical random numbers can be modulated by performing exclusive OR of the physical random numbers and the M-sequence pseudo random numbers. For example, when the M-sequence is a 16-bit, a probability of“0” to occur is ranged from about 49.999 to 50.001% for the output random numbers, which can satisfy the performance of the random numbers.

In the case of the hopping mode, by switching the M-sequences with the use of the physical random numbers, the output pattern of the random numbers is made difficult to be predicted. Since the output random numbers are not the physical random numbers directly output, even if the physical random numbers are manipulated by external influences, security can be prevented from deteriorating as compared to the case of using only the physical random numbers, which is because the M-sequence pseudo random numbers are output. As described above, by providing a plurality of registers storing the tap positions of the M-sequence, for example, the M-sequence can be switched based on the physical random number.

In the random number generating circuit 54A, in the case of the multiplication mode, the tap positions of the M-sequence is stored by the mask A register 65, and the feedback signal (F) to the linear feedback shift register 64 is generated based on the data (Q₀ to Q₃₁) stored in the linear feedback shift register 64 and the data (AQ₀ to AQ₃₁) stored in the mask A register 65. Therefore, by setting desired data in the mask A register 65, the tap positions of the M-sequence can be changed freely. In such a random number generating circuit 54A, since the tap positions are variable, a level of prediction difficulty is increased in the pseudo random numbers generated by the linear feedback shift register 64. In the random number generating circuit that can generate a plurality of the M-sequences, the circuit scale can be reduced since circuits are not required to be provided correspondingly to the tap positions of the respective M-sequences.

The random numbers (R) can be generated by modulating the physical random numbers with the use of the pseudo random numbers generated in this way. Therefore, if the level of prediction difficulty of the random numbers is increased by modulating the physical random numbers with the use of the M-sequence pseudo random numbers, the tap positions of the M-sequence can be changed freely. Therefore, the level of prediction difficulty of the random numbers can be increased along with the circuit scale reduced as compared to the case of configuring the tap positions of a plurality of the M-sequences with circuits in advance.

The random number generating circuit 54A is provided with two registers, i.e., the mask A register 65 and the mask B register 66 that store the tap positions of the M-sequence. The feedback signal (F) to the linear feedback shift register 64 is generated based on the data (Q₀ to Q₃₁) stored in the linear feedback shift register 64 and the data (AQ₀ to AQ₃l or BQ₀ to BQ₃₁) stored in one of the registers selected by the multiplexer 67. In other words, by setting desired data in the mask A register 65 and the mask B register 66, the tap positions of two M-sequences which can be switched by the selection signal (SEL), can be changed freely. In such a random number generating circuit 54A, since the M-sequences can be switched based on the selection signal (SEL) and the tap positions can be changed freely by the setting of the mask A register 65 and the mask B register 66, the level of prediction difficulty is increased in the pseudo random numbers generated by the linear feedback shift register 64. The circuit scale can be reduced since circuits are not required to be provided correspondingly to the tap positions of the respective M-sequences.

The selection signal (SEL) input to the multiplexer 67 can be the physical random number (PHRQ). Again, in the case the level of prediction difficulty of the random numbers is increased by switching the M-sequences depending on the physical random numbers, the tap positions of the M-sequence can be changed freely. Therefore, the level of prediction difficulty of the random numbers is increased and the circuit scale can be reduced as compared to the case of configuring the tap positions of a plurality of the M-sequences with circuits in advance.

The above described implementation is for the purpose of facilitating the understanding of the present invention, rather than construing in a limited manner. The present invention may be modified and altered without deviating from the spirit thereof and the present invention includes equivalents thereof.

For example, although two registers, i.e., the mask A register 65 and the mask B register 66 store the tap positions of the M-sequences in the random number generating circuit 54A of the present implementation, three or more registers may be provided to store the tap positions. If three or more registers are provided to store the tap positions, for example, two or more bits of the physical random numbers may be stored with the use of a flip-flop, etc. and the register outputting the tap positions may be selected depending on that value.

Although the M-sequence is used as the pseudo random number sequence in the implementation, other pseudo random number sequences may be used, such as a Gold-sequence, for example. If the Gold-sequence is used as the pseudo random number sequence, the level of prediction difficulty of the random numbers is also increased by modulating the physical random numbers with the use of the Gold-sequence pseudo random numbers to generate the random numbers. In the case of using the Gold-sequence, since the physical random numbers are not output directly, even if the physical random numbers are manipulated by external influences, security can be prevented from being deteriorated as compared to the case of using only the physical random numbers, because the Gold-sequence pseudo random numbers are output.

By providing a plurality of registers storing the tap positions of the Gold-sequence and by selecting the register outputting the tap positions based on the physical random numbers, the Gold-sequences can be switched. In this way, the level of prediction difficulty is increased in the pseudo random numbers and security can be prevented from being deteriorated by external influences.

Although two registers, i.e., the mask A register 65 and the mask B register 66 store the tap positions of the M-sequences in the random number generating circuit 54A of the present implementation, three or more registers may be provided to store the tap positions. If three or more registers are provided to store the tap positions, for example, two or more bits of the physical random numbers may be stored with the use of a flip-flop, etc. and the register outputting the tap positions may be selected depending on that value.

When the Gold-sequence is used as the pseudo random number sequence, by configuring the tap positions thereof to be stored in the register, the tap positions can be changed freely, and the circuit scale can be reduced as compared to the case of configuring circuits correspondingly to a plurality of the tap positions in advance.

Although the random number generating circuit 54A is used for the encryption in the keyless entry system 1 in the present implementation, the random number generating circuit 54A can be applied to various information processing systems using random numbers to enhance the security, other than the keyless entry system 1. In this way, by applying the random number generating circuit 54A to various information processing systems, random numbers that are difficult to be predicted and that have security prevented from being deteriorated by outside effects as well can be obtained, and thus the security of such information processing systems can be enhanced. By applying the random number generating circuit 54A to various information processing systems, the tap positions of the pseudo random number sequence can be changed freely, thus the degree of prediction difficulty of the random numbers can be improved to enhance the security. Since circuits are not required to be configured correspondingly to the tap positions of a plurality of the pseudo random number sequences in advance, the circuit scale of the random number generating circuit is reduced, and the apparatus using the random number generating circuit can be miniaturized.

Although the preferred implementation of the present invention has been described in detail, it should be understood that various changes, substitutions and alterations can be made therein without departing from spirit and scope of the inventions as defined by the appended claims.

What is claimed is:

1. A random number generating circuit comprising:
a pseudo random number generating circuit that generates pseudo random numbers of a pseudo random number sequence;
a physical random number generating circuit that generates physical random numbers; and
a modulation circuit that changes the physical random numbers generated by the physical random number generating circuit depending on the pseudo random numbers generated by the pseudo random number generating circuit and outputs the changed physical random numbers.

2. The random number generating circuit of claim 1, wherein the modulation circuit has a circuit that performs exclusive OR of the physical random numbers generated by the physical random number generating circuit and the pseudo random numbers generated by the pseudo random number generating circuit.

3. A random number generating circuit comprising:
a pseudo random number generating circuit that generates pseudo random numbers of a plurality of pseudo random number sequences; and
a physical random number generating circuit that generates physical random numbers,
wherein the pseudo random number generating circuit switches the pseudo random number sequences generated by the pseudo random number generating circuit based on the physical random numbers generated by the physical random number generating circuit.

4. The random number generating circuit of claim 3, wherein the pseudo random number sequences are M-sequences, and
wherein the pseudo random number generating circuit has
a linear feedback shift register,
a plurality of registers that stores respective tap positions of a plurality of the M-sequences,
a selection circuit that selects any one of the plurality of registers based on the physical random numbers generated by the physical random number generating circuit, and
a feedback signal generating circuit that generates a feedback signal to the linear feedback shift register based on data stored in the linear feedback shift register and the tap positions stored in the register selected by the selection circuit.

5. A random number generating circuit comprising:
a linear feedback shift register that generates pseudo random numbers of a pseudo random number sequence;
a register that stores tap positions of the pseudo random number sequence; and
a feedback signal generating circuit that generates a feedback signal to the linear feedback shift register based on data stored in the linear feedback shift register and the tap positions stored in the register.

6. The random number generating circuit of claim 5,
wherein the register is constituted to have the same number of bits as the linear feedback shift register and stores one logical value into bits corresponding to the tap positions of the pseudo random number sequence and the other logical value into bits other than the bits corresponding to the tap positions, and
wherein the feedback signal generating circuit has a circuit that performs logical AND of each bit of the linear feedback shift register and each bit of the register, and a circuit that generates the feedback signal from exclusive OR of the data obtained by the logical AND.

7. The random number generating circuit of claim 5, comprising:
a physical random number generating circuit that generates physical random numbers; and
a modulation circuit that changes the physical random numbers generated by the physical random number generating circuit depending on the pseudo random numbers generated by the linear feedback shift register and outputs the changed physical random numbers.

8. The random number generating circuit of claim 6, comprising:
a physical random number generating circuit that generates physical random numbers; and
a modulation circuit that changes the physical random numbers generated by the physical random number generating circuit depending on the pseudo random numbers generated by the linear feedback shift register and outputs the changed physical random numbers.

9. A random number generating circuit comprising:
a linear feedback shift register that generates pseudo random numbers of a pseudo random number sequence;
a plurality of registers that stores respective tap positions of a plurality of the pseudo random number sequences;
a selection circuit that receives a selection signal indicating which pseudo random number sequence is to be used among the plurality of the pseudo random number sequences, and selects any one of the registers based on the selection signal; and
a feedback signal generating circuit that generates a feedback signal to the linear feedback shift register based on data stored in the linear feedback shift register and the tap positions stored in the register selected by the selection circuit.

10. The random number generating circuit of claim 9,
wherein the register is constituted to have the same number of bits as the linear feedback shift register and stores one logical value into bits corresponding to the tap positions of the pseudo random number sequence and the other logical value into bits other than the bits corresponding to the tap positions, and
wherein the feedback signal generating circuit has a circuit that performs logical AND of each bit of the linear feedback shift register and each bit of the register selected by the selection circuit, and a circuit that generates the feedback signal from exclusive OR of the data obtained by the logical AND.

11. The random number generating circuit of claim 9, further comprising a physical random number generating circuit that generates physical random numbers,
wherein the selection signal is the physical random number generated by the physical random number generating circuit.

12. The random number generating circuit of claim 10, further comprising a physical random number generating circuit that generates physical random numbers,
wherein the selection signal is the physical random numbers generated by the physical random number generating circuit.
